(19) United States
(12) Patent Application Publication
(10) Pub. No.: US 2021/0315024 A1
(43) Pub. Date: Oct. 7, 2021

(54) INDICATION OF RESOURCE COLLISIONS IN SIDELINK

(71) Applicant: QUALCOMM Incorporated, San Diego, CA (US)

(72) Inventors: Gabi SARKIS, San Diego, CA (US); Sudhir Kumar BAGHEL, Hillsborough, NJ (US); Kapil GULATI, Montgomery, NJ (US); Seyedkianoush HOSSEINI, San Diego, CA (US); Tien Viet NGUYEN, Bridgewater, NJ (US)

(21) Appl. No.: 17/167,794

(22) Filed: Feb. 4, 2021

Related U.S. Application Data
(60) Provisional application No. 63/005,779, filed on Apr. 6, 2020.

(51) Int. Cl. H04W 74/08; H04W 24/10

(52) U.S. Cl. CPC H04W 74/0858; H04W 92/18; H04W 24/10

(57) ABSTRACT

Certain aspects of the present disclosure provide techniques for indication of resource collisions in sidelink. A method that may be performed by a user equipment (UE) includes generating information including one or more resource collisions between sidelink devices. The method generally includes transmitting the information to at least one of the sidelink devices.

### CROSS-REFERENCE TO RELATED APPLICATIONS

This application claims benefit of and priority to U.S. Provisional Application No. 63/005,779, filed Apr. 6, 2020, which is hereby assigned to the assignee hereof and hereby expressly incorporated by reference herein in its entireties as if fully set forth below and for all applicable purposes.

### FIELD OF THE DISCLOSURE

Aspects of the present disclosure relate to wireless communications, and more particularly, to techniques for indicating resource collisions in sidelink.

### INTRODUCTION

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved indication of resource collisions in sidelink.

Certain aspects of the subject matter described in this disclosure can be implemented in a method for wireless communication by a node. The method generally includes generating information including one or more resource collisions between sidelink devices and transmitting the information to at least one of the sidelink devices.

Certain aspects of the subject matter described in this disclosure can be implemented in an apparatus for wireless communication by a node. The apparatus generally includes at least one processor configured to generate information including one or more resource collisions between sidelink devices and transmit the information to at least one of the sidelink devices. Additionally, in some cases, the apparatus may include a memory coupled with the at least one processor.

Certain aspects of the subject matter described in this disclosure can be implemented in an apparatus for wireless communication by a node. The apparatus generally includes means for generating information including one or more resource collisions between sidelink devices and means for transmitting the information to at least one of the sidelink devices.

Certain aspects of the subject matter described in this disclosure can be implemented in a non-transitory computer readable medium for wireless communication by a node. The non-transitory computer readable medium generally includes instructions that, when executed by at least one processor, cause the at least one processor to generate information including one or more resource collisions between sidelink devices and transmit the information to at least one of the sidelink devices.

Certain aspects of the subject matter described in this disclosure can be implemented in a method for wireless communication by a node. The method generally includes receiving information including one or more resource collisions between sidelink devices and determining a resource reservation for transmission based, at least in part, on the information.

Certain aspects of the subject matter described in this disclosure can be implemented in an apparatus for wireless communication by a node. The apparatus generally includes at least one processor configured to receive information including one or more resource collisions between sidelink devices and determine a resource reservation for transmission based, at least in part, on the information. Additionally, in some cases, the apparatus may include a memory coupled with the at least one processor.

Certain aspects of the subject matter described in this disclosure can be implemented in an apparatus for wireless communication by a node. The apparatus generally includes means for receiving information including one or more resource collisions between sidelink devices and means for determining a resource reservation for transmission based, at least in part, on the information.

Certain aspects of the subject matter described in this disclosure can be implemented in a non-transitory computer readable medium for wireless communication by a node. The non-transitory computer readable medium generally includes instructions that, when executed by at least one processor, cause the at least one processor to receive information including one or more resource collisions between sidelink devices and determine a resource reservation for transmission based, at least in part, on the information.

Aspects of the present disclosure provide means for, apparatus, processors, and computer-readable mediums for performing techniques and methods that may be complementary to the operations by the UE described herein, for example, by a BS.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4A and FIG. 4B show diagrammatic representations of example vehicle to everything (V2X) systems, in accordance with certain aspects of the present disclosure.

FIGS. 5A-5B illustrate example resource reservations made by a node in accordance with certain aspects of the present disclosure.

FIG. 6 illustrates an example coordination information delivery between nodes, in accordance with certain aspects of the present disclosure.

FIG. 7 is a flow diagram illustrating example operations for wireless communication by a node, in accordance with certain aspects of the present disclosure.

FIG. 8 is another flow diagram illustrating example operations for wireless communication by a node, in accordance with certain aspects of the present disclosure.

FIG. 9 illustrates a communications device that may include various components configured to perform operations for the techniques disclosed herein in accordance with aspects of the present disclosure.

FIG. 10 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for indicating resource collisions in sidelink.

In sidelink, devices may reserve resources in the time and frequency domain for transmission. Resource allocations by different devices can collide. The devices can exchange coordination information to help reduce the resource collisions.

Aspects of the present disclosure provide types of coordination information that can be shared or exchanged. In certain aspects, the coordination information includes information about resource collisions. The resource collisions indicated in the coordination information may be collisions that have already happened, collisions predicted to happen in the future, or both. The resource collisions indicated in the coordination information may be collisions of periodic resource allocations, aperiodic resource allocations, or both. In certain aspects, additional information related to the resource collisions may be indicated. The resource collisions indicated may be limited. For example, the resource collisions indicated in the coordination information may be reported or indicated based on particular conditions being met. Indicating coordination information in such a fashion may provide improved efficiency with making resource reservations for sidelink devices and a decreased chance of resource collisions.

The following description provides examples of indicating resource collisions in sidelink in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

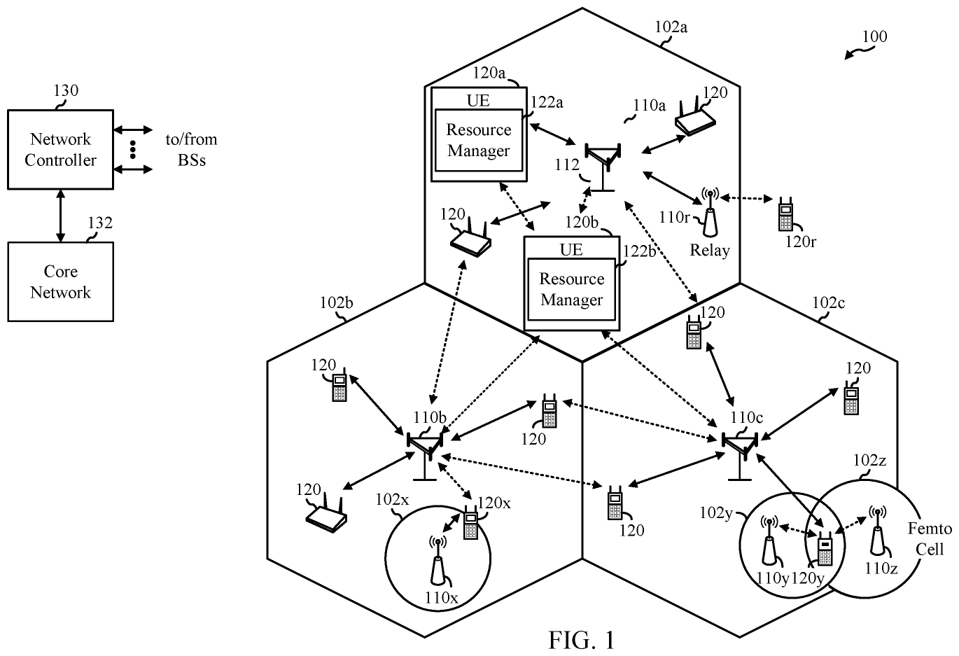

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

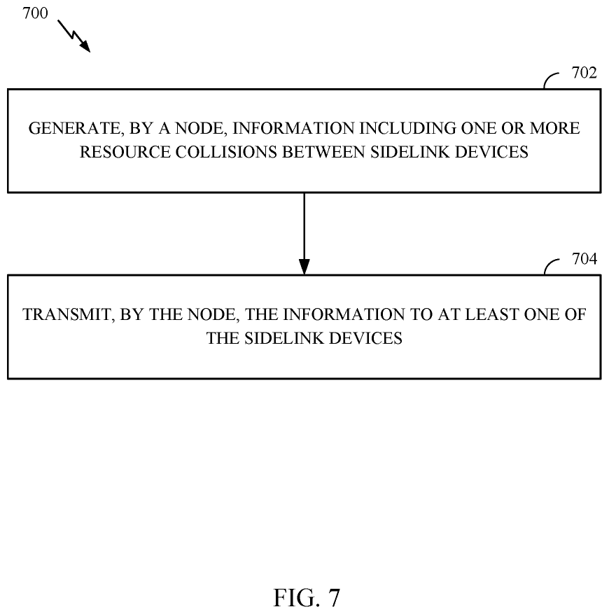

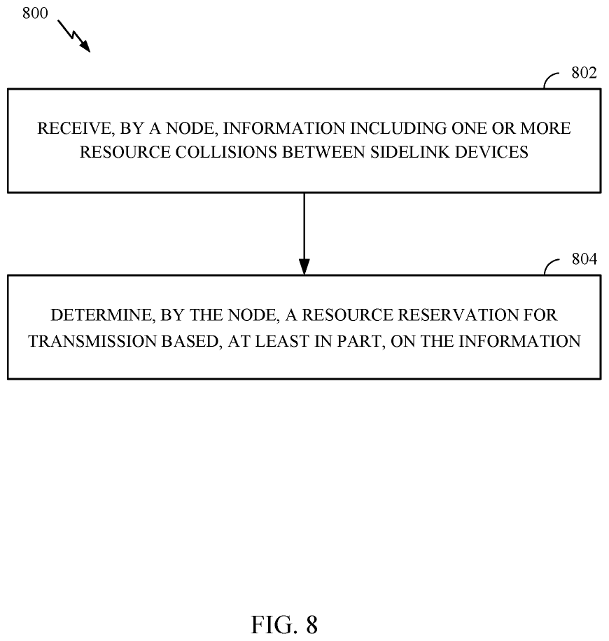

According to certain aspects, nodes, such as the BSs 110 and/or the UEs 120, may be configured for sidelink. The nodes may be configured for exchanging coordination information for mitigating and/or avoiding resource collisions in sidelink. As shown in FIG. 1, the UE 120a and UE 120b include a resource manager 122a and resource manager 122b, respectively, that may be configured to perform the operations shown in FIGS. 7-8, as well as other operations disclosed herein for indicating resource collisions in sidelink, in accordance with aspects of the present disclosure.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

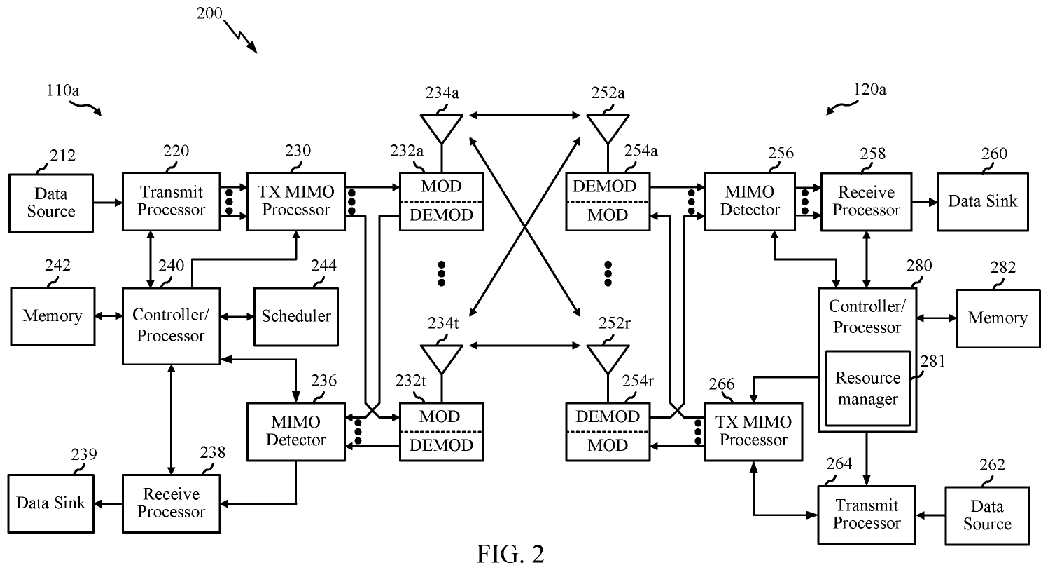

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 280 of the UE 120a includes a resource manager 281 that may be configured to perform the operations shown in FIGS. 7-8, as well as other operations disclosed herein for indicating resource collisions in sidelink, according to aspects described herein. Although shown at the controller/processor, other components of the UE 120a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

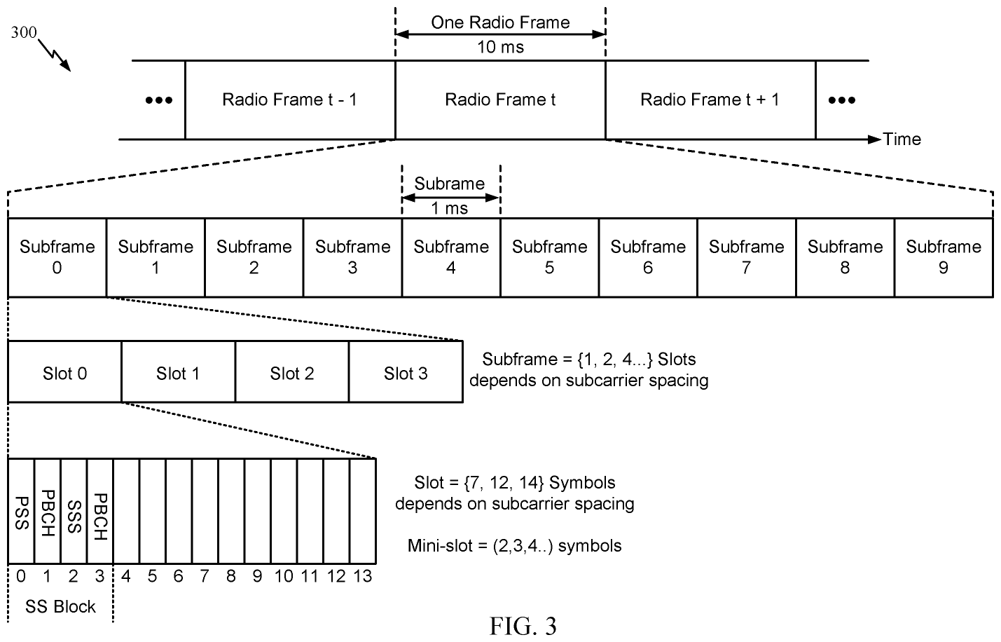

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

In some examples, the communication between the UEs 120 and BSs 110 is referred to as the access link. The access link may be provided via a Uu interface. Communication between devices may be referred as the sidelink.

In some examples, two or more subordinate entities (e.g., UEs 120) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE 120a) to another subordinate entity (e.g., another UE 120) without relaying that communication through the scheduling entity (e.g., UE 120 or BS 110), even though the scheduling entity may be utilized for scheduling and/or control purposes. In some examples, the sidelink signals may be communicated using a licensed spectrum (unlike wireless local area networks, which typically use an unlicensed spectrum). One example of sidelink communication is PC5, for example, as used in V2V, LTE, and/or NR.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions. The PSFCH may carry feedback such as CSI related to a sidelink channel quality.

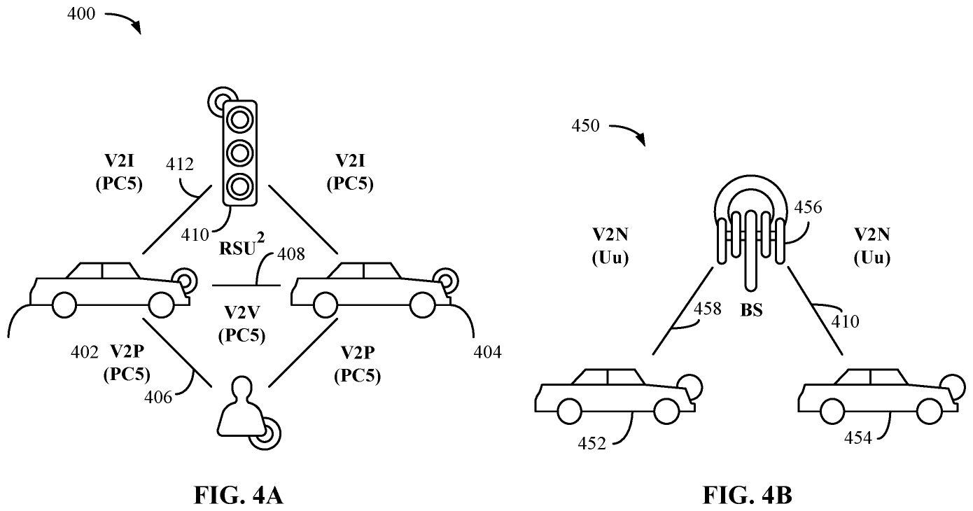

FIG. 4A and FIG. 4B show diagrammatic representations of example V2X systems, in accordance with some aspects of the present disclosure. For example, the vehicles shown in FIG. 4A and FIG. 4B may communicate via sidelink channels and may perform sidelink CSI reporting as described herein.

The V2X systems, provided in FIG. 4A and FIG. 4B provide two complementary transmission modes. A first transmission mode, shown by way of example in FIG. 4A, involves direct communications (for example, also referred to as side link communications) between participants in proximity to one another in a local area. A second transmission mode, shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle to vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 410 may be used, for example, for long range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NB-type RSUs have similar functionality as the Macro eNB/gNB. The Micro NB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

In certain systems (e.g., certain NR systems), resource allocation may be reservation based in sidelink. For example, a sidelink device may reserve one or more sub-channels in the frequency domain in a slot in the time domain. The sidelink device may reserve resources in the current slot and resources in up to two future slots. In some examples, the sidelink device may send reservation information in sidelink control information (SCI). The SCI may be transmitted with data. The sidelink resource allocation may be aperiodic and/or periodic. In some examples, for periodic resource reservations, the period may be configured (e.g., between 0 ms and 1000 ms). The period configuration may be included in the SCI.

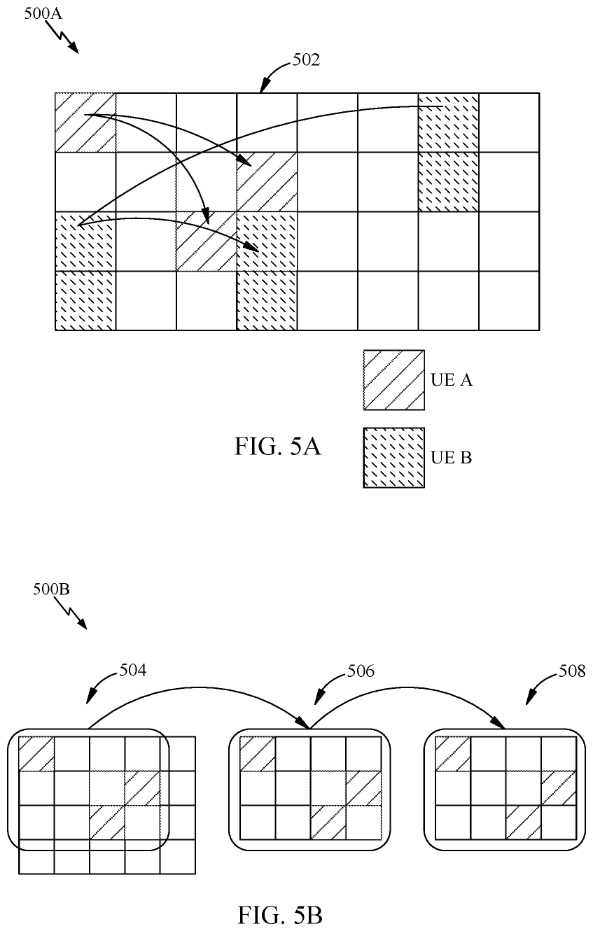

In some cases, two UEs can reserve the same sidelink resource or resources (or some of the same resources), as shown in FIG. 5A, which may lead to resource collisions. For example, as shown in FIG. 5A, two UEs (e.g., UE A and UE B) may reserve sidelink resources in the same slot 502, leading to a resource collision in slot 502. In some cases, UE A and UE B may be examples of UE 120a illustrated in FIGS. 1 and 2.

Resource collisions may occur in both aperiodic and periodic reservations. However, resource collisions for periodic reservations may be more severe. For example, as shown in FIG. 5B, for periodic resource reservations on the sidelink, the resource reservation may be repeated in period 504, 506, 508. Because the reservation is periodic, the collisions may be recurring. For example, two UEs can reserve the same period resource having the same or similar period, leading to persistent collisions. For example, if UE A and UE B both used periodic reservations, then the collision shown in FIG. 5A may occur in each of the reserved periods on the sidelink.

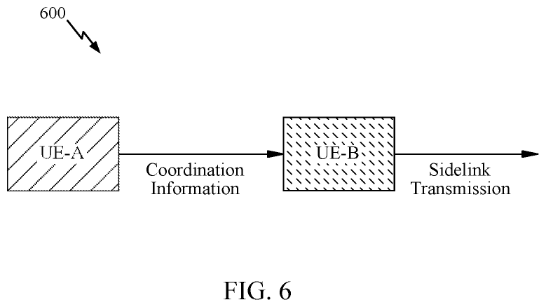

In an attempt to reduce resource collisions, sidelink UEs (e.g., UE-A and UE-B) may send (or exchange) coordination information, as shown in FIG. 6, and may use the coordination information to make or reselect resource reservations. For example, in some cases, as shown, one sidelink UE (e.g., UE-A) may generate and share coordination information with multiple UEs (e.g., multiple UE-Bs). Alternatively or additionally, a single sidelink UE (e.g., UE-B) may receive coordination information from multiple other sidelink UEs (e.g., multiple UE-As). Sidelink UEs that receive coordination information may use the coordination information to better select resources for transmissions to avoid resource collisions.

Accordingly, what is needed are techniques and apparatus for sharing coordination information in sidelink.

### Example Indication of Resource Collision in Sidelink

Aspects of the present disclosure provide techniques and apparatus for coordination information that can be indicated (e.g., provided, shared or exchanged) in sidelink. In certain aspects, the coordination information includes information about resource collisions.

As explained above, sidelink devices, or nodes, such as user equipment (e.g., UEs A and B of FIG. 6, which may include UE 120a illustrated in FIGS. 1 and 2) may coordinate with one another to efficiently and effectively reserve resources. For example, coordination information may be exchanged between different UEs to indicate resources collisions.

In some cases, the coordination information may, for example, indicate collisions that have already happened (e.g., indication of past collisions). Exchanging coordination information that indicates collisions in the past may be useful for periodic reservations.

Additionally or alternatively, the coordination information may indicate collisions predicted to happen in the future (e.g., indication of future collisions). Exchanging coordination information that indicates future collisions may be useful for both periodic and aperiodic reservations. In some cases, future collisions may be determined based on the periodicity of resource reservations. For example, if a resource reservation (or collision) is periodic, then future reservations (or collisions) may be predicted based on the periodicity.

According to aspects, the collisions may be indicated in a variety of ways. For example, in some cases, the collisions may be indicated as a map of all resources including an indication of which resources are involved in a collision (e.g., past, present, or future collisions). In other cases, the collisions may be indicated as a list of resources with collisions. That is, the list of resources with collisions may indicate only the resources that are involved collisions (e.g., past, present, or future collisions). In yet another case, the collisions may be indicated by transmitting the resource reservations associated with the collisions.

In some examples, additional information besides the resource collisions may be indicated. For example, such additional information may include information such as the sender(s) (e.g., a source ID), intended recipient(s) (e.g., a destination ID), priority of the payload, and the like, associated with the colliding reservations or transmissions. According to certain aspects, the resource collisions indicated in the coordination information may be reported or indicated based on conditions being satisfied.

FIG. 7 is a flow diagram illustrating example operations 700 for wireless communication, for example, for indicating resource collisions in sidelink, in accordance with certain aspects of the present disclosure. The operations 700 may be performed, for example, by a node, such as a UE 120a and/or a BS 110a. For example, in some cases, operations 700 may be performed by a sidelink UE 120a and/or UE 120b in the wireless communication network 100 and/or a roadside unit, such as the UE 120a or BS 110a. The operations 700 may be implemented as software components that are executed and run on one or more processors (e.g., controller/processor 280 of FIG. 2). Further, the transmission and reception of signals by the UE in operations 700 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 700 begin, at block 702, by generating, by a node, information including one or more resource collisions between sidelink devices.

In some cases, the operations 700 may include determining the one or more resource collisions based on at least partially overlapping resource reservations by the node, the sidelink devices, or both. In certain aspects, the resource reservations may include periodic resource reservations, aperiodic resource reservations, or both. Additionally, in some cases, the resource reservations may be indicated in sidelink control information (SCI) sent by the node, received from the sidelink devices, or both.

In some cases, generating the information including one or more resource collisions at 702 may include generating information including one or more previous collisions, one or more expected future collisions, or both. Additionally, in some cases, operations 700 may include generating information including only previous collisions when the collisions are between periodic resource reservations.

At block 704, the node may transmit the information to at least one of the sidelink devices. In some cases, the information may be transmitted in a second part of SCI or in a medium access control (MAC) control element (CE).

In some cases, operations 700 may further include transmitting a bitmap indicating all configured resources and, for each of the configured resources, whether there is a collision. Alternatively or additionally, the operations 700 may include transmitting a list of the resources having a collision. In certain aspects, transmitting the list of only the resources having a collision may be an efficient way to share coordination information with other UEs. Alternatively or additionally, the operations 700 may include transmitting one or more resource reservations associated with the one or more resource collisions.

In some cases, operations 700 may include transmitting a source identifier (ID) associated with the one or more resource collisions, such an identifier of the sidelink device or devices that transmit on a colliding resource. Additionally or alternatively, operations 700 may include transmitting a destination ID associated with the one or more resource collisions, such as an identifier of an intended recipient of a transmission on a colliding resource. Additionally or alternatively, operations 700 may include transmitting a periodicity associated with the one or more resource collisions, such as a period of a periodic resource reservation (e.g., such as a semi-persistent scheduling (SPS) resource reservation). Additionally or alternatively, operations 700 may include transmitting an indication of whether a collision is period or aperiodic.

Additionally or alternatively, operations 700 may include transmitting a priority associated with the one or more resource collisions, such as a priority of the data or the channel associated with a transmission on a colliding resource.

The operations 700 may include transmitting information including (or indicates) only a subset of the one or more resource collisions. In some cases, the subset of collisions for transmission may be selected based on conditions (e.g., criteria).

For example, in certain aspects, the subset of the one or more resource collisions may include collisions involving resource reservations having a priority at or above a threshold priority level. For example, in some cases, the node (e.g., sidelink device) may only indicate collisions, and/or information associated with the collisions (e.g., such as the additional information discussed above), that are associated with a priority level (e.g., a predetermined or preconfigured priority level). In some cases, the priority level associated with the collisions may be determined based on SCI. In other cases, the priority level associated with the collisions may be determined based on the payload or content of colliding transmissions. According to aspects, when the colliding resources reservations are associated with a priority level below the threshold, the node/sidelink device may not send an indication of the collision and/or the information associated with the collision.

In certain aspects, the subset of the one or more resource collisions may include collisions involving resource reservations for transmissions from sidelink devices in a same group. For example, in some cases, the node/sidelink device may only indicate collisions, and/or information associated with the collisions (e.g., such as the additional information discussed above), that are from devices in a same group of devices. For example, the sidelink device may determine whether the colliding resource reservations originate from devices in a same group of devices based on the source IDs and/or a group ID and, when the colliding resource reservations originate from devices in different groups of devices, the sidelink device may not send an indication of the collision and/or the information associated with the collision.

In certain aspects, the subset of the one or more resource collisions may include collisions involving resource reservations for transmissions to sidelink devices in a same group. For example, the sidelink device may only indicate collisions, and/or information associated with the collisions (e.g., such as the additional information discussed above), that are addressed to a same group of devices. For example, the sidelink device may determine whether the colliding resource reservations are addressed to a same group of devices based on the destination IDs and/or a group ID and, when the colliding reservations are addressed to devices in different groups of devices, the sidelink device may not send an indication of the collision and/or the information associated with the collision.

In certain aspects, the subset of the one or more resource collisions may include collisions involving resource reservations for transmissions to a same sidelink device. For example, the sidelink device may only indicate collisions, and/or information associated with the collisions (e.g., such as the additional information discussed above), that are addressed to a same device. For example, in some cases, the sidelink device may determine whether the colliding resource reservations are addressed to a same device based on the destination IDs and, when the colliding resource reservations are addressed to different devices, the sidelink device may not send an indication of the collision and/or the information associated with the collision.

In certain aspects, the subset of the one or more resource collisions may include collisions involving resource reservations for transmissions from sidelink devices within a threshold distance from each other. For example, in some cases, the sidelink device may only indicate collisions, and/or information associated with the collisions (e.g., such as the additional information discussed above), when the colliding resource reservations originate from devices in a same zone or from nearby zones. For example, the sidelink device may determine whether the colliding resource reservations originate from the same zone based on a source ID or a zone ID associated with the colliding resource reservations. In some examples, nearby zones may include zones within a threshold distance from each other and/or within a defined geographic area. Accordingly, in certain cases, when the distance between the sidelink devices is at or above the threshold, the sidelink device may not send an indication of the collision and/or the information associated with the collision.

In certain aspects, the subset of the one or more resource collisions may include collisions involving at least two transmissions having a difference in a measured reference signal reception power (RSRP) that is below a threshold. For example, the sidelink device may only indicate collisions, and/or information associated with the collisions (e.g., such as the additional information discussed above), when the difference in measured RSRP (and/or other signal strength and/or signal quality measurement) of two transmissions is below a threshold (e.g., a predetermined or configured threshold). In some cases, when the difference in measured RSRP is at or above the threshold, the sidelink device may not send an indication of the collision and/or the information associated with the collision.

In certain aspects, the subset of the one or more resource collisions may include collisions involving at least two transmissions having a measured RSRP that is above a threshold. For example, in some cases, the sidelink device may only indicate collisions, and/or information associated with the collisions (e.g., such as the additional information discussed above), when the measured RSRP (and/or other signal strength and/or signal quality measurement) of two transmissions is above a threshold (e.g., a predetermined or configured threshold). In some cases, when the measured RSRP for one or both of the transmissions is at or below the threshold, the sidelink device may not send an indication of the collision and/or the information associated with the collision.

In some cases, the information including the collisions, and/or the information associated with the collisions (e.g., such as the additional information discussed above), may be groupcast. In some examples, the destination ID of the groupcast information may indicate the sidelink devices associated with the one or more resource collisions. In some examples, a separate indication may be provided to indicate the groups of devices associated with the collisions.

FIG. 8 is another flow diagram illustrating example operations 800 for wireless communication, for example, for indicating resource collisions in sidelink, in accordance with certain aspects of the present disclosure. The operations 800 may be performed, for example, by node (e.g., a sidelink UE 120a in the wireless communication network 100 or a UE). The operations 800 may be implemented as software components that are executed and run on one or more processors (e.g., controller/processor 280 of FIG. 2). Further, the transmission and reception of signals by the UE in operations 800 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 800 may begin, at block 802, by receiving, by a node, information including one or more resource collisions between sidelink devices.

At block 804, the node may determine a resource reservation for transmission based, at least in part, on the information. For example, in some cases, the node may determine a resource reservation using different resources than the colliding resources.

In certain aspects, receiving the information including the one or more resource collisions between the sidelink devices may include receiving information including one or more previous collisions, one or more expected future collisions, or both. In some cases, information including the one or more previous resource collisions may be received (and transmitted) when the collisions are between periodic resource reservations, aperiodic resource reservations, or both.

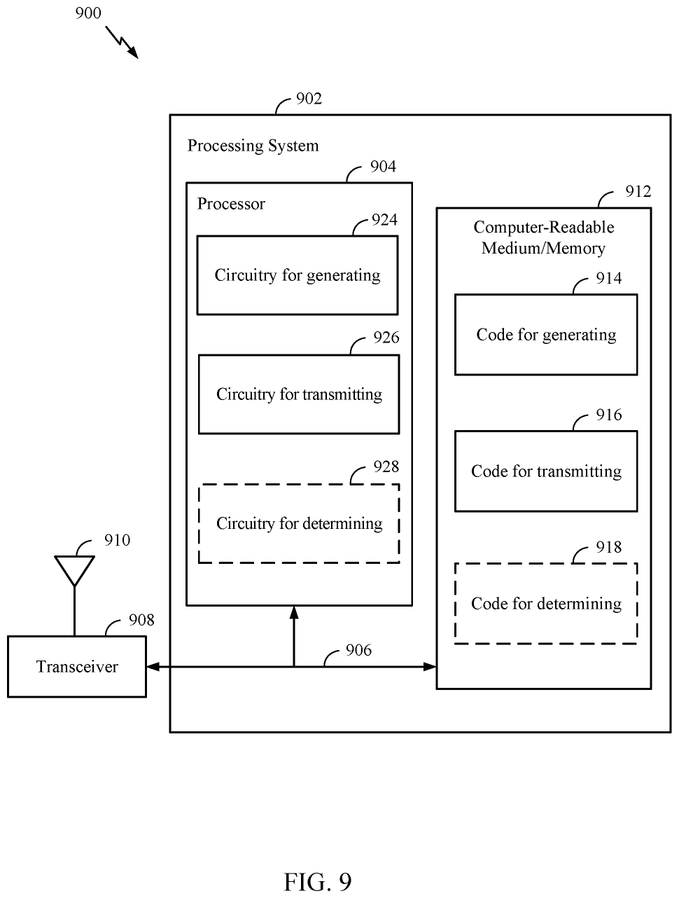

FIG. 9 illustrates a communications device 900 that may include various components configured to perform operations for the techniques disclosed herein, such as the operations illustrated in FIG. 7, as well as other operations described herein for indicating resource collisions in sidelink. The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes a processor 904 coupled to a computer-readable medium/memory 912 via a bus 906. In certain aspects, the computer-readable medium/memory 912 is configured to store instructions (e.g., computer-executable code) that when executed by the processor 904, cause the processor 904 to perform the operations illustrated in FIG. 7, as well as other operations for performing the various techniques discussed herein for indicating resource collisions in sidelink. In some cases, the processor 904 can include one or more components of UE 120a with reference to FIG. 2 such as, for example, controller/processor 280 (including the resource manager 281), transmit processor 264, receive processor 258, and/or the like. Additionally, in some cases, the computer-readable medium/memory 912 can include one or more components of UE 120a with reference to FIG. 2 such as, for example, memory 282 and/or the like.

In certain aspects, computer-readable medium/memory 912 stores code 914 for generating code 916 for transmitting; and code 918 for determining.

In some cases, code 914 for generating may include code for generating information including one or more resource collisions between sidelink devices.

In some cases, code 916 for transmitting may include code for transmitting the information to at least one of the sidelink devices.

In some cases, code 918 for determining may include code for determining the one or more resource collisions based on at least partially overlapping resource reservations by the node, the sidelink devices, or both.

In some cases, code 916 for transmitting may include code for transmitting the information in a second part of sidelink control information (SCI) or a medium access control (MAC) control element (CE).

In some cases, code 914 for generating may include code for generating information including one or more previous collisions, one or more expected future collisions, or both.

In some cases, code 914 for generating may include code for generating information including one or more previous collisions when the one or more resource collisions are between periodic resource reservations, aperiodic resource reservations, or both.

In some cases, code 916 for transmitting may include code for transmitting a bitmap indicating all configured resources and, for each of the configured resources, whether there is a collision.

In some cases, code 916 for transmitting may include code for transmitting one or more resource reservations associated with the one or more resource collisions.

In some cases, code 916 for transmitting may include code for transmitting a list of resources having a collision.

In some cases, code 916 for transmitting may include code for transmitting a source identifier (ID) associated with the one or more resource collisions, a destination ID associated with the one or more resource collisions, a periodicity associated with the one or more resource collisions, a priority associated with the one or more resource collisions, or a combination thereof.

In some cases, code 916 for transmitting may include code for transmitting information including only a subset of the one or more resource collisions.

In some cases, code 916 for transmitting may include code for groupcasting the information, and wherein a destination identifier (ID) of the groupcast information or a separate indication indicates the sidelink devices associated with the one or more resource collisions.

In certain aspects, the processor 904 has circuitry configured to implement the code stored in the computer-readable medium/memory 912. The processor 904 includes circuitry 924 for generating, circuitry 926 for transmitting; and circuitry 928 for determining.

In some cases, circuitry 924 for generating may include circuitry for generating information including one or more resource collisions between sidelink devices.

In some cases, circuitry 926 for transmitting may include circuitry for transmitting the information to at least one of the sidelink devices.

In some cases, circuitry 928 for determining may include circuitry for determining the one or more resource collisions based on at least partially overlapping resource reservations by the node, the sidelink devices, or both.

In some cases, circuitry 926 for transmitting may include circuitry for transmitting the information in a second part of sidelink control information (SCI) or a medium access control (MAC) control element (CE).

In some cases, circuitry 924 for generating may include circuitry for generating information including one or more previous collisions, one or more expected future collisions, or both.

In some cases, circuitry 924 for generating may include circuitry for generating information including one or more previous collisions when the one or more resource collisions are between periodic resource reservations, aperiodic resource reservations, or both.

In some cases, circuitry 926 for transmitting may include circuitry for transmitting a bitmap indicating all configured resources and, for each of the configured resources, whether there is a collision.

In some cases, circuitry 926 for transmitting may include circuitry for transmitting one or more resource reservations associated with the one or more resource collisions.

In some cases, circuitry 926 for transmitting may include circuitry for transmitting a list of resources having a collision.

In some cases, circuitry 926 for transmitting may include circuitry for transmitting a source identifier (ID) associated with the one or more resource collisions, a destination ID associated with the one or more resource collisions, a periodicity associated with the one or more resource collisions, a priority associated with the one or more resource collisions, or a combination thereof.

In some cases, circuitry 926 for transmitting may include circuitry for transmitting information including only a subset of the one or more resource collisions.

In some cases, circuitry 926 for transmitting may include circuitry for groupcasting the information, and wherein a destination identifier (ID) of the groupcast information or a separate indication indicates the sidelink devices associated with the one or more resource collisions.

In some cases, the operations illustrated in FIG. 7, as well as other operations for performing the various techniques discussed herein for indicating resource collisions, may be implemented by one or means-plus-function components. For example, in some cases, such operations may be implemented by means for generating, means for transmitting (or means for outputting for transmission), and means for determining.

In some cases, means for transmitting (or means for outputting for transmission) includes the transceiver 254 and/or antenna(s) 252 of the UE 120a illustrated in FIG. 2 and/or circuitry 926 for transmitting of the communication device 900 in FIG. 9.

In some cases, means for generating and means for determining include a processing system, which may include one or more processors, such as the receive processor 258, the transmit processor 264, the TX MIMO processor 266, and/or the controller/processor 280 of the UE 120a illustrated in FIG. 2 and/or the processing system 902 of the communication device 900 in FIG. 9.

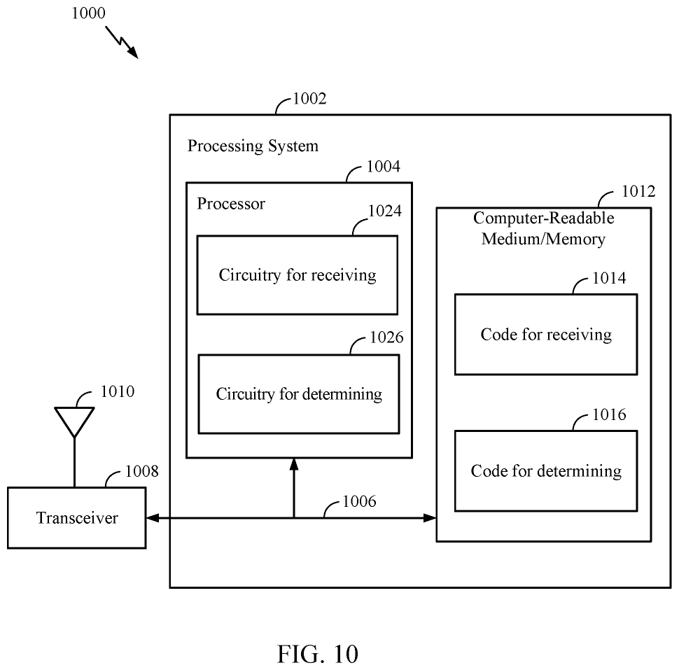

FIG. 10 illustrates a communications device 1000 that may include various components (e.g., corresponding to means-plus-function components) configured to perform operations for the techniques disclosed herein, such as the operations illustrated in FIG. 8, as well as other operations described herein for indicating resource collisions in sidelink. The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 8, as well as other operations for performing the various techniques discussed herein for indicating resource collisions in sidelink. In some cases, the processor 904 can include one or more components of UE 120a with reference to FIG. 2 such as, for example, controller/processor 280 (including the resource manager 281), transmit processor 264, receive processor 258, and/or the like. Additionally, in some cases, the computer-readable medium/memory 912 can include one or more components of UE 120a with reference to FIG. 2 such as, for example, memory 282 and/or the like.

In certain aspects, computer-readable medium/memory 1012 stores code 1014 for receiving, code 1016 for determining.

In some cases, code 1014 for receiving may include code for receiving information including one or more resource collisions between sidelink devices.

In some cases, code 1016 for determining may include code for determining a resource reservation for transmission based, at least in part, on the information.

In some cases, code 1014 for receiving may include code for receiving the information in a second part of sidelink control information (SCI) or in a medium access control (MAC) control element (CE).

In some cases, code 1014 for receiving may include code for receiving a bitmap indicating all configured resources and, for each of the configured resources, whether there is a collision.

In some cases, code 1014 for receiving may include code for receiving one or more resource reservations associated with the one or more resource collisions.

In some cases, code 1014 for receiving may include code for receiving a list of resources having a collision.

In some cases, code 1014 for receiving may include code for receiving a source identifier (ID) associated with the one or more resource collisions, a destination ID associated with the one or more resource collisions, a periodicity associated with the one or more resource collisions, a priority associated with the one or more resource collisions, or a combination thereof.

In some cases, code 1014 for receiving may include code for receiving groupcast information.

In some cases, code 1014 for receiving may include code for receiving information from a plurality of sidelink devices.

In certain aspects, the processor 1004 has circuitry configured to implement the code stored in the computer-readable medium/memory 1012. The processor 1004 includes circuitry 1024 for receiving and circuitry 1026 for determining.

In some cases, circuitry 1024 for receiving may include circuitry for receiving information including one or more resource collisions between sidelink devices.

In some cases, circuitry 1026 for determining may include circuitry for determining a resource reservation for transmission based, at least in part, on the information.

In some cases, circuitry 1024 for receiving may include circuitry for receiving the information in a second part of sidelink control information (SCI) or in a medium access control (MAC) control element (CE).

In some cases, circuitry 1024 for receiving may include circuitry for receiving a bitmap indicating all configured resources and, for each of the configured resources, whether there is a collision.

In some cases, circuitry 1024 for receiving may include circuitry for receiving one or more resource reservations associated with the one or more resource collisions.

In some cases, circuitry 1024 for receiving may include circuitry for receiving a list of resources having a collision.

In some cases, circuitry 1024 for receiving may include circuitry for receiving a source identifier (ID) associated with the one or more resource collisions, a destination ID associated with the one or more resource collisions, a periodicity associated with the one or more resource collisions, a priority associated with the one or more resource collisions, or a combination thereof.

In some cases, circuitry 1024 for receiving may include circuitry for receiving groupcast information.

In some cases, circuitry 1024 for receiving may include circuitry for receiving information from a plurality of sidelink devices.

In some cases, the operations illustrated in FIG. 8, as well as other operations for performing the various techniques discussed herein for indicating resource collisions, may be implemented by one or means-plus-function components. For example, in some cases, such operations may be implemented by means for receiving and means for determining.

In some cases, means for receiving includes the transceiver 254 and/or antenna(s) 252 of the UE 120a illustrated in FIG. 2 and/or circuitry 926 for receiving of the communication device 1000 in FIG. 10.

In some cases, means for determining include a processing system, which may include one or more processors, such as the receive processor 258, the transmit processor 264, the TX MIMO processor 266, and/or the controller/processor 280 of the UE 120a illustrated in FIG. 2 and/or the processing system 1002 of the communication device 1000 in FIG. 10.

### Example Clauses

Implementation examples are described in the following numbered clauses:

Clause 1: A method of wireless communication by a node, comprising: generating information including one or more resource collisions between sidelink devices; and transmitting the information to at least one of the sidelink devices.

Clause 2: The method of Clause 1, further comprising determining the one or more resource collisions based on at least partially overlapping resource reservations by the node, the sidelink devices, or both.

Clause 3: The method of Clause 2, wherein the resource reservations include periodic resource reservations, aperiodic resource reservations, or both.

Clause 4: The method of any of Clauses 2-3, wherein the resource reservations are indicated in sidelink control information (SCI) sent by the node, received from the sidelink devices, or both.

Clause 5: The method of any of Clauses 1-4, wherein transmitting the information comprises transmitting the information in a second part of sidelink control information (SCI) or a medium access control (MAC) control element (CE).

Clause 6: The method of any of Clauses 1-5, wherein the node comprises a roadside unit (RSU) or a sidelink user equipment (UE).

Clause 7: The method of any of Clauses 1-6, wherein generating the information including the one or more resource collisions between the sidelink devices comprises generating information including one or more previous collisions, one or more expected future collisions, or both.

Clause 8: The method of Clause 7, wherein generating the information including the one or more resource collisions between the sidelink devices comprises generating information including one or more previous collisions when the one or more resource collisions are between periodic resource reservations, aperiodic resource reservations, or both.

Clause 9: The method of any of Clauses 1-8, wherein transmitting the information to the at least one of the sidelink devices comprises transmitting a bitmap indicating all configured resources and, for each of the configured resources, whether there is a collision.

Clause 10: The method of any of Clauses 1-9, wherein transmitting the information to the at least one of the sidelink device comprises transmitting one or more resource reservations associated with the one or more resource collisions.

Clause 11: The method of any of Clauses 1-10, wherein transmitting the information to the at least one of the sidelink devices comprises transmitting a list of resources having a collision.

Clause 12: The method of any of Clauses 1-11, further comprising transmitting a source identifier (ID) associated with the one or more resource collisions, a destination ID associated with the one or more resource collisions, a periodicity associated with the one or more resource collisions, a priority associated with the one or more resource collisions, or a combination thereof.

Clause 13: The method of any of Clauses 1-12, wherein transmitting the information to the at least one of the sidelink devices comprises transmitting information including only a subset of the one or more resource collisions.

Clause 14: The method of Clause 13, wherein the subset of the one or more resource collisions comprises collisions involving resource reservations having a priority at or above a threshold priority level.

Clause 15: The method of any of Clauses 13-14, wherein the subset of the one or more resource collisions comprises collisions involving resource reservations for transmissions from sidelink devices in a same group.

Clause 16: The method of any of Clauses 13-15, wherein the subset of the one or more resource collisions comprises collisions involving resource reservations for transmissions to sidelink devices in a same group.

Clause 17: The method of any of Clauses 13-16, wherein the subset of the one or more resource collisions comprises collisions involving resource reservations for transmissions to a same sidelink device.

Clause 18: The method of any of Clauses 13-17, wherein the subset of the one or more resource collisions comprises collisions involving resource reservations for transmissions from sidelink devices within a threshold distance from each other.

Clause 19: The method of any of Clauses 13-18, wherein the subset of the one or more resource collisions comprises collisions involving at least two transmissions having a difference in a measured reference signal reception power (RSRP) that is below a threshold.

Clause 20: The method of any of Clauses 13-19, wherein the subset of the one or more resource collisions comprises collisions involving at least two transmissions having a measured reference signal reception power (RSRP) that is above a threshold.

Clause 21: The method of any of Clauses 1-10, wherein transmitting the information to the at least one of the sidelink devices comprises groupcasting the information, and wherein a destination identifier (ID) of the groupcast information or a separate indication indicates the sidelink devices associated with the one or more resource collisions.

Clause 22: A method of wireless communication by a node, comprising: receiving information including one or more resource collisions between sidelink devices; and determining a resource reservation for transmission based, at least in part, on the information.

Clause 23: The method of Clause 22, wherein the resource reservations is a periodic resource reservations or an aperiodic resource reservations.

Clause 24: The method of Clauses 22-23, wherein receiving the information comprises receiving the information in a second part of sidelink control information (SCI) or in a medium access control (MAC) control element (CE).

Clause 25: The method of any of Clauses 22-24, wherein the node comprises a sidelink user equipment (UE).

Clause 26: The method of any of Clauses 22-25, wherein the information includes one or more previous collisions, one or more expected future collisions, or both.

Clause 27: The method of any of Clauses 22-26, wherein the information includes one or more previous collisions between periodic resource reservations, aperiodic resource reservations, or both.

Clause 28: The method of and of Clauses 22-27, wherein receiving the information comprises receiving a bitmap indicating all configured resources and, for each of the configured resources, whether there is a collision.

Clause 29: The method of any of Clauses 22-28, wherein receiving the information comprises receiving one or more resource reservations associated with the one or more resource collisions.

Clause 30: The method of any of Clauses 22-29, wherein receiving the information to comprises receiving a list of resources having a collision.

Clause 31: The method of any of Clauses 22-30, further comprising receiving a source identifier (ID) associated with the one or more resource collisions, a destination ID associated with the one or more resource collisions, a periodicity associated with the one or more resource collisions, a priority associated with the one or more resource collisions, or a combination thereof.

Clause 32: The method of any of Clauses 22-31, wherein the information includes collisions involving resource reservations having a priority at or above a threshold priority level.

Clause 33: The method of any of Clauses 22-32, wherein the information includes collisions involving resource reservations for transmissions from sidelink devices in a same group.

Clause 34: The method of any of Clauses 22-33, wherein the information includes collisions involving resource reservations for transmissions to sidelink devices in a same group.

Clause 35: The method of any of Clauses 22-34, wherein the information includes collisions involving resource reservations for transmissions to a same sidelink device.

Clause 36: The method of any of Clauses 22-35, wherein the information includes collisions involving resource reservations for transmissions from sidelink devices within a threshold distance from each other.

Clause 37: The method of any of Clauses 22-36, wherein the information includes collisions involving at least two transmissions having a difference in a measured reference signal reception power (RSRP) that is below a threshold.

Clause 38: The method of any of Clauses 22-37, wherein the information includes collisions involving at least two transmissions having a measured reference signal reception power (RSRP) that is above a threshold.

Clause 39: The method of any of Clauses 22-38, wherein receiving the information from the at least one of the sidelink devices comprises receiving groupcast information.

Clause 40: The method of Clause 39, wherein a destination ID of the groupcast information or a separate indication indicates the sidelink devices associated with the one or more resource collisions.

Clause 41: The method of any of Clauses 22-40, wherein receiving the information comprises receiving information from a plurality of sidelink devices.

Clause 42: An apparatus for wireless communication, comprising: at least one processor and a memory coupled to the at least one processor, the memory comprising code executable by the at least one processor to cause the apparatus to perform a method in accordance with any one of Clauses 1-41.

Clause 43: An apparatus for wireless communication, comprising means for performing a method in accordance with any one of Clauses 1-41.

Clause 44: A non-transitory computer-readable medium comprising instructions that, when executed by one or more processors, cause the one or more processors to perform a method in accordance with any one of Clauses 1-41.

Clause 45: A computer program product embodied on a computer-readable storage medium comprising code for performing a method in accordance with any one of Clauses 1-41.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS), LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 7 and/or FIG. 8, as well as other operations described herein for indicating resource collisions in sidelink.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
at least one processor; and
a memory coupled to the at least one processor, the memory comprising code executable by the at least one processor to cause the apparatus to:
generate information including one or more resource collisions between sidelink devices; and
transmit the information to at least one of the sidelink devices.

2. The apparatus of claim 1, wherein the memory further comprises code executable by the at least one processor to cause the apparatus to determine the one or more resource collisions based on at least partially overlapping resource reservations by the apparatus, the sidelink devices, or both.

3. The apparatus of claim 2, wherein the resource reservations include periodic resource reservations, aperiodic resource reservations, or both.

4. The apparatus of claim 2, wherein the resource reservations are indicated in sidelink control information (SCI) sent by the apparatus, received from the sidelink devices, or both.

5. The apparatus of claim 1, wherein the code executable by the at least one processor to cause the apparatus to transmit the information comprises code to cause the apparatus to transmit the information in a second part of sidelink control information (SCI) or a medium access control (MAC) control element (CE).

6. The apparatus of claim 1, wherein the apparatus comprises a roadside unit (RSU) or a sidelink user equipment (UE).

7. The apparatus of claim 1, wherein the code executable by the at least one processor to cause the apparatus to generate the information including the one or more resource collisions between the sidelink devices comprises code executable by the at least one processor to cause the apparatus to generate information including one or more previous collisions, one or more expected future collisions, or both.

8. The apparatus of claim 7, wherein the code executable by the at least one processor to cause the apparatus to generate the information including the one or more resource collisions between the sidelink devices comprises code executable by the at least one processor to cause the apparatus to generate information including one or more previous collisions when the one or more resource collisions are between periodic resource reservations, aperiodic resource reservations, or both.

9. The apparatus of claim 1, wherein the code executable by the at least one processor to cause the apparatus to transmit the information to the at least one of the sidelink devices comprises at least one of:
code executable by the at least one processor to cause the apparatus to transmit a bitmap indicating all configured resources and, for each of the configured resources, whether there is a collision; or
code executable by the at least one processor to cause the apparatus to transmit a list of resources having a collision.

10. The apparatus of claim 1, wherein the code executable by the at least one processor to cause the apparatus to transmit the information to at least one of the sidelink devices comprises code executable by the at least one processor to cause the apparatus to transmit one or more resource reservations associated with the one or more resource collisions.

11. The apparatus of claim 1, wherein the memory further comprises code executable by the at least one processor to cause the apparatus to transmit a source identifier (ID) associated with the one or more resource collisions, a destination ID associated with the one or more resource collisions, a periodicity associated with the one or more resource collisions, a priority associated with the one or more resource collisions, or a combination thereof.

12. The apparatus of claim 1, wherein the code executable by the at least one processor to cause the apparatus to transmit the information to the at least one of the sidelink devices comprises code executable by the at least one processor to cause the apparatus to transmit information including only a subset of the one or more resource collisions.

13. The apparatus of claim 12, wherein the subset of the one or more resource collisions comprises at least one of:
collisions involving resource reservations having a priority at or above a threshold priority level;
collisions involving resource reservations for transmissions from sidelink devices in a same group;
collisions involving resource reservations for transmissions to sidelink devices in a same group;
collisions involving resource reservations for transmissions to a same sidelink device;
collisions involving resource reservations for transmissions from sidelink devices within a threshold distance from each other;
collisions involving at least two transmissions having a difference in a measured reference signal reception power (RSRP) that is below a threshold; or
collisions involving at least two transmissions having a measured reference signal reception power (RSRP) that is above a threshold.

14. The apparatus of claim 1, wherein the code executable by the at least one processor to cause the apparatus to transmit the information to the at least one of the sidelink devices comprises code executable by the at least one processor to cause the apparatus to groupcast the information, and wherein a destination identifier (ID) of the groupcast information or a separate indication indicates the sidelink devices associated with the one or more resource collisions.

15. An apparatus for wireless communication, comprising:
at least one processor; and
a memory coupled to the at least one processor, the memory comprising code executable by the at least one processor to cause the apparatus to:
receive information including one or more resource collisions between sidelink devices; and
determine a resource reservation for transmission based, at least in part, on the information.

16. The apparatus of claim 15, wherein the resource reservation is a periodic resource reservation or an aperiodic resource reservation.

17. The apparatus of claim 15, wherein the code executable by the at least one processor to cause the apparatus to receive the information comprises code executable by the at least one processor to cause the apparatus to receive the information in a second part of sidelink control information (SCI) or in a medium access control (MAC) control element (CE).

18. The apparatus of claim 15, wherein the apparatus comprises a sidelink user equipment (UE).

19. The apparatus of claim 15, wherein the information includes one or more previous collisions, one or more expected future collisions, or both.

20. The apparatus of claim 15, wherein the information includes one or more previous collisions between periodic resource reservations, aperiodic resource reservations, or both.

21. The apparatus of claim 15, wherein the code executable by the at least one processor to cause the apparatus to receive the information comprises code executable by the at least one processor to cause the apparatus to receive a bitmap indicating all configured resources and, for each of the configured resources, whether there is a collision.

22. The apparatus of claim 15, wherein the code executable by the at least one processor to cause the apparatus to receive the information comprises code executable by the at least one processor to cause the apparatus to receive one or more resource reservations associated with the one or more resource collisions.

23. The apparatus of claim 15, wherein the code executable by the at least one processor to cause the apparatus to receive the information comprises code executable by the at least one processor to cause the apparatus to receive a list of resources having a collision.

24. The apparatus of claim 15, wherein the memory further comprises code executable by the at least one processor to cause the apparatus to receive a source identifier (ID) associated with the one or more resource collisions, a destination ID associated with the one or more resource collisions, a periodicity associated with the one or more resource collisions, a priority associated with the one or more resource collisions, or a combination thereof.

25. The apparatus of claim 15, wherein the information includes at least one of:
collisions involving resource reservations having a priority at or above a threshold priority level;
collisions involving resource reservations for transmissions from sidelink devices in a same group;
collisions involving resource reservations for transmissions to sidelink devices in a same group;
collisions involving resource reservations for transmissions to a same sidelink device;
collisions involving resource reservations for transmissions from sidelink devices within a threshold distance from each other;
collisions involving at least two transmissions having a difference in a measured reference signal reception power (RSRP) that is below a threshold; or
collisions involving at least two transmissions having a measured reference signal reception power (RSRP) that is above a threshold.

26. The apparatus of claim 15, wherein the code executable by the at least one processor to cause the apparatus to receive the information from the at least one of the sidelink devices comprises code executable by the at least one processor to cause the apparatus to receive groupcast information.

27. The apparatus of claim 26, wherein a destination ID of the groupcast information or a separate indication indicates the sidelink devices associated with the one or more resource collisions.

28. The apparatus of claim 15, wherein the code executable by the at least one processor to cause the apparatus to receiving the information comprises code executable by the at least one processor to cause the apparatus to receive information from a plurality of sidelink devices.

29. A method for wireless communication by a node, comprising:
generating information including one or more resource collisions between sidelink devices; and
transmitting the information to at least one of the sidelink devices.

30. A method of wireless communication by a node, comprising:
receiving information including one or more resource collisions between sidelink devices; and
determining a resource reservation for transmission based, at least in part, on the information.
